(19) United States
(12) Patent Application Publication
(10) Pub. No.: US 2026/0310242 A1
(43) Pub. Date: Oct. 8, 2026

(54) DIGITAL GAS ASSIST WITH FLOW CONTROL AND GAUGE

(71) Applicant: Dionex Corporation, Sunnyvale, CA (US)

(72) Inventors: Gary L Gleave, Pleasanton, CA (US); Mrinal Sengupta, Union City, CA (US); Andres R Honegger, Pleasanton, CA (US); Paul Stuart, Redwood City, CA (US)

(21) Appl. No.: 19/483,280

(22) PCT Filed: May 21, 2024
(86) PCT No.: PCT/US2024/030356

§ 371 Date: Nov. 11, 2025

Related U.S. Application Data
(60) Provisional application No. 63/503,559, filed on May 22, 2023.

(51) Int. Cl. G05D 7/06; G01N 30/32

(52) U.S. Cl. CPC G05D 7/0635; G01N 30/32; G01N 2030/324; G01N 2030/328

(57) ABSTRACT

Gas control devices, and associated methods and systems, are described herein. In one aspect, a method can include determining whether at least one of (1) a characteristic C1 associated with gas entering a gas valve and (2) a characteristic C2 associated with gas exiting the gas valve satisfies a condition, the gas valve being fluidically coupled to a gas regulator and a gas output, and the gas valve being convertible among at least (1) a first state in which the gas regulator and the gas output are placed into fluid communication with one another and (2) a second state in which the gas regulator and the gas output are placed into fluid isolation from one another; and based on the determining, causing the gas valve to convert from one of the first state to the other of the second state.

### CROSS-REFERENCE TO RELATED APPLICATIONS

This application is the U.S. National Stage, under 35 U.S. C § 371, of international application PCT/US2024/030356, having an international filing date of May 21, 2024, which claims priority to and the benefit of U.S. Provisional Application No. 63/503,559 , “Digital Gas Assist with Flow Control and Gauge” (filed May 22, 2023), the entirety of which application is incorporated herein by reference for any and all purposes.

### TECHNICAL FIELD

The present invention relates generally to digital gas assist control and gauge devices, and particularly for chromatography systems.

### BACKGROUND

In liquid delivery systems and various chromatography applications involving fluid flow, there are several needs to provide a gaseous media to either fully push fluid through its wetted path or to provide a gas assist especially inert gases such as ultrapure helium or nitrogen in the delivery of fluid flow. Fluid flow performance is often improved through applying a metered constant positive pressure at the start of the liquid source. Oftentimes this positive gas pressure is described as a headspace gas to assist in the uniform delivery of the liquid and to minimize intrusion of gases such as oxygen or carbon dioxide from the ambient. This can introduce unwanted conductivity background drift, high noise and potential contamination from carbonate peaks in the chromatograms. Aside from providing a headspace gas assist, the pressurized feed can also be used to deliver a sample, a reagent or a regenerant solutions. In many instances the pressurized feed can provide a ripple free delivery approach resulting in improved chromatographic noise performance. In existing systems, the ability to control this gas flow is performed using manually adjustable valves and awareness of the gas pressure levels is only observed using analog pressure gauges. Because of the variability in manual control, among other challenges, having an enhanced ability to enable or control the flow of the gas and monitor relevant pressures is highly desirable.

### SUMMARY

A digital gas assist with flow control and gauge device, and associated systems and methods, are described herein. The device can enable or disable flow through a digitally controllable solution via an electronic interface. The device can include a calibrated pressure transducer providing the user a real-time digitally sensed monitor or reading of the set gas pressure level. In some cases, the device can be plumbed in a purge-only orientation allowing for regulated gas to be enabled or disabled to vacate a tubing path of any liquid. In some cases, the device can also allow for digital setting or control of the actual pressure level of delivered gas. The digital interface to the device can be built into an instrument or can be developed into a wired or wireless external communication interface.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 depicts a front view of a chromatography system incorporating a gas control device according to the present disclosure.

FIG. 2 depicts a rear view of a chromatography system incorporating a gas control device according to the present disclosure.

FIGS. 3 and 4 depict a gas control device according to the present disclosure.

FIG. 5 depicts a display and gas control device according to the present disclosure.

FIG. 6 depicts a display for a gas control device according to the present disclosure.

FIG. 7 depicts an exploded view of a gas control device according to the present disclosure.

FIG. 8 depicts a gas control device according to the present disclosure.

FIG. 9 depicts a gas control device according to the present disclosure.

FIG. 10 depicts a gas control device according to the present disclosure.

FIG. 11 depicts a process for implementing a gas control device according to the present disclosure.

FIG. 12 depicts a controller for implementing a gas control device according to the present disclosure.

### DETAILED DESCRIPTION

The present disclosure may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable, and it should be understood that steps can be performed in any order. Any documents cited herein are incorporated by reference in their entireties for any and all purposes.

It is to be appreciated that certain features of the invention which are, for clarity, described herein in the context of separate embodiments, can also be provided in combination in a single embodiment. Conversely, various features of the invention that are, for brevity, described in the context of a single embodiment, can also be provided separately or in any subcombination. Further, reference to values stated in ranges include each and every value within that range. In addition, the term “comprising” should be understood as having its standard, open-ended meaning, but also as encompassing “consisting” as well. For example, a device that comprises Part A and Part B can include parts in addition to Part A and Part B, but can also be formed only from Part A and Part B.

The present disclosure provides a gas control device, and associated systems and methods. The gas control device can provide users with the ability to enable or disable the regulated gas flow to an incorporated instrument. Typically, a house source or gas cylinder provides an immediate larger regulated pressure of gas. This facility gas source is distributed to one or more targeted instruments for more specific use. Each individual analytical instrument platform then would benefit from the disclosed technology further managing the available gas flow.

According to the present disclosure, gas can enter into a lower pressure regulator of a gas control device. A user can set a desired pressure level, which can be based on parameters or characteristics of a sample interrogation system coupled to the gas control device; such a sample interrogation system can be, for example, a chromatography system. A gas pressure relief valve can be included to provide an additional plumbed-in safety device at a set maximum allowed level. In some cases, a manually adjustable gas regulator can be included. In some cases, the gas control device can include an electronic or digitally controlled gas regulator. The gas control device can allow for pressure reading of the regulated gas pressure through the use of plumbed-in gas pressure transducers. One or more pressure transducers can be included to allow for pressure measurement upstream or downstream from a gas on/off valve. The analog signals from the pressure transducers can be sampled and converted to digital values representing the pressure. A multi-display numeric display can provide visual feedback of gas pressures. The digital signal values can also be communicated to applications instrumentation for additional display and programmable use.

The pressure display can also include a toggle switch that can control the on or off state of the gas enabling valve. The controllability of the gas valve can also be available to the application instrumentation for remote or programmable use.

The regulated gas can be gated to the inlet of a manifold by the use of an on/off valve. One or more downstream bottles or other gas plumbed devices can be fed the controlled gas through outlet ports of the manifold. The manifold can include one or more output ports equipped with a range of fittings. The gas control device can include quick-disconnect fitting which are static valved inline or bulkhead tubing connectors that are normally closed for each unused port. Once connected, the valves can be enabled and the target devices can receive their shared gas flow.

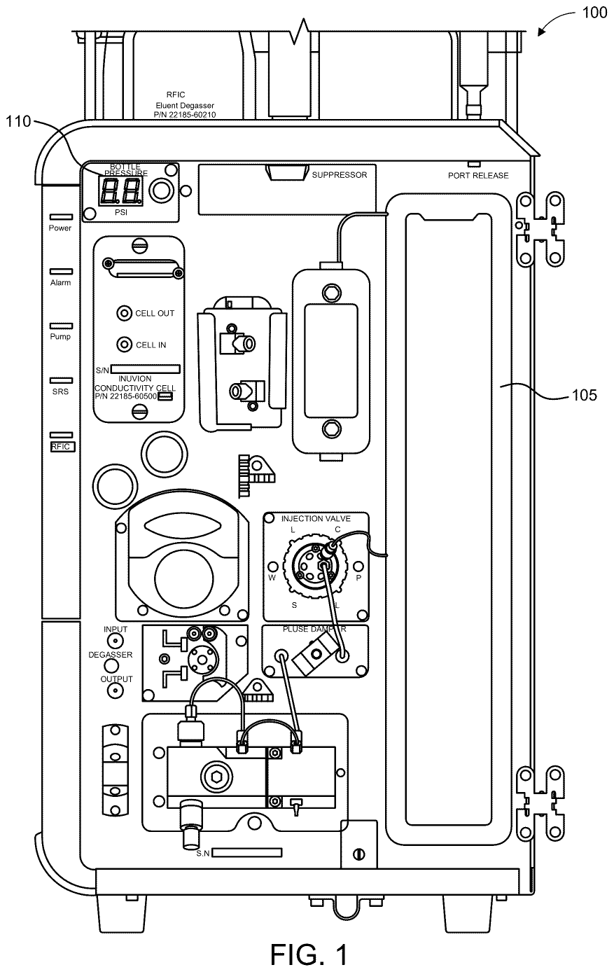

FIG. 1 depicts a front view of a sample interrogation system 100 according to the present disclosure. In some cases, the sample interrogation system 100 can include a chromatography system, such as a gas chromatography system or a liquid chromatography system.

The sample interrogation system 100 can include a column 105, which can be configured to transport fluid, such as liquid, gas, or both. The column 105 can receive fluid via an inlet, from one or more sample containers. In some cases, the sample containers are configured to hold eluent, which can be carried via the column 105 to one or more detectors of the system. The detectors can sense or measure properties of the fluid, which can be further analyzed via a computing system of the sample interrogation system 100 (or via an external computing system).

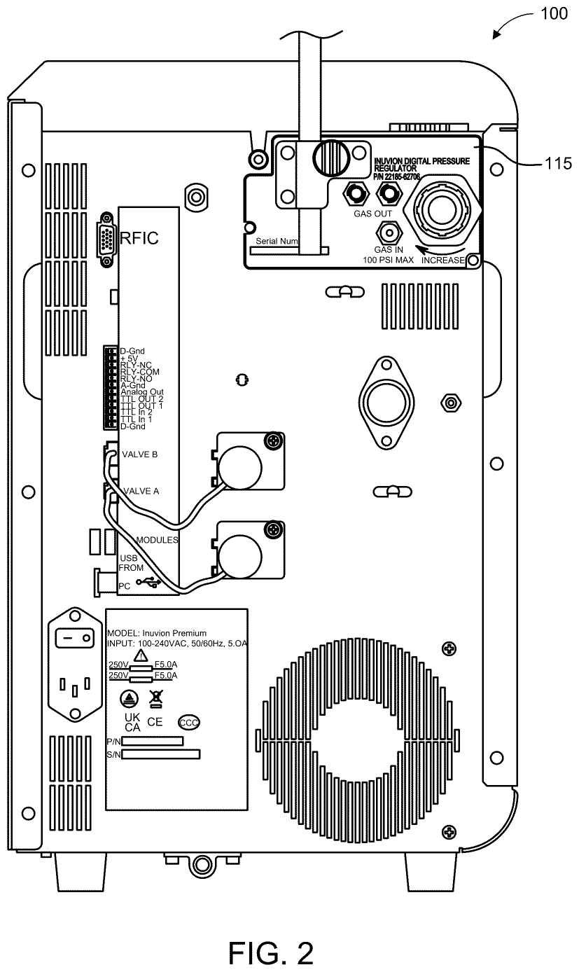

FIG. 2 depicts a rear view of the sample interrogation system 100. The sample interrogation system 100 can include a gas control device for regulating gas flow to the sample interrogation system 100, for example via the sample containers of the system 100. The gas control device can include a gas regulator and a display. A gas regulator panel 115 of the gas regulator is shown in FIG. 2, and a display 110 is shown in FIG. 1. In some cases, the display 110 can be located on a front surface of the sample interrogation system 100, which can provide ease of use for a user. In some cases, the regulator panel 115 can be located on a rear surface of the sample interrogation system 100, which can a location of a source gas input for typical sample interrogation systems, for example, for retrofitting sample interrogation systems with the gas control device.

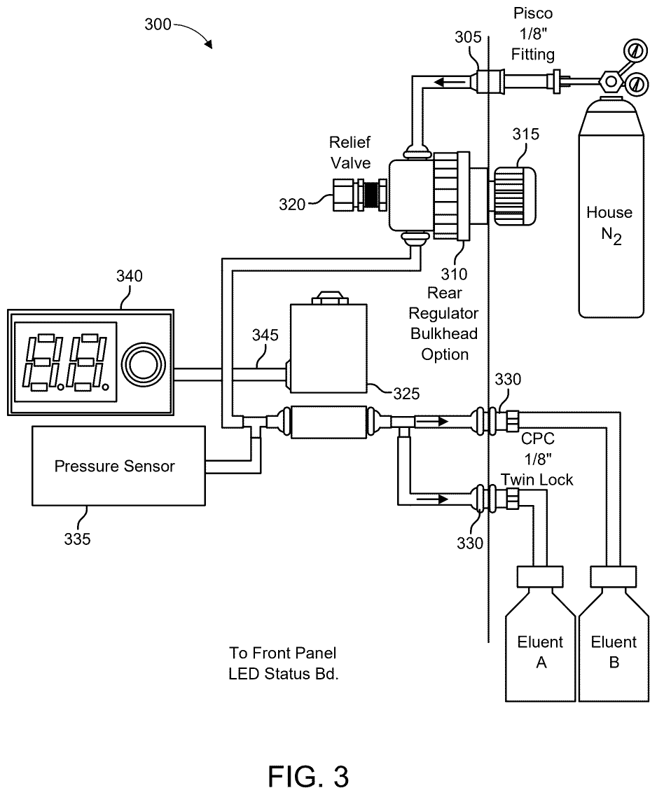

FIG. 3 depicts a gas control device 300 according to the present disclosure. In some cases, gas control device 300 can be an example of the gas control device discussed with reference to FIGS. 1 and 2. For example, the gas regulator 115 and the display 110 of FIGS. 1 and 2 can be components of the gas control device 300. In other cases, the gas control device 300 can be a stand-alone device, for example without coupling to house gas sources or output components.

The gas control device 300 can include an input 305 configured to receive gas from a source. For example, the input 305 can be configured to receive a gas from a house gas source, such as nitrogen, argon, and the like. The input 305 can be configured to include different connector types for coupling to a gas source. For example, the input 305 can include a spring-loaded compressor that (1) closes the input 305 when no connection is made; such a connection can be via a connector of the gas control device 300 or via a connector of a gas source, and (2) open when a connector is coupled to the input 305, thereby allowing gas to flow into the gas control device 300. In some cases, the input 305 can include a push-to-connect fitting configured to couple to a valved quick-disconnect fitting (e.g., of a source gas), or vice versa. Other fitting examples can include a compression fitting, a quick-disconnect fitting, a threaded fitting, and the like.

The input 305 can be fluidically coupled to a gas regulator 310. The gas regulator 310 can regulate the gas pressure received from the input 305. For example, the gas regulator 310 can be a spring-controlled regulator, where a regulator chamber size is spring-modified to accommodate a desired or set pressure, which can be set, for example, by a user. The gas regulator 310 can also include a knob 315 or other control mechanism for a user to control the pressure. For example, a user can turn the knob 315 to either increase or decrease the gas pressure within a regulator chamber of the gas regulator 310. In some cases, the gas regulator 310 can include a relief valve 320. The relief valve 320 can be configured to vent gas from the gas regulator 310 when the pressure in the gas regulator 310 exceeds a pressure threshold. In some cases, the pressure threshold of the relief valve 320 can be configured according to parameters of the gas control device 300, or according to components connected to output of the gas control device 300. For example, the pressure threshold can be configured to limit the gas pressure from exceeding a maximum pressure of a sample container coupled to an output of the gas control device 300. In some cases, the relief valve can be energized either mechanically or electronically via feedback from a gas flow sensor.

The gas regulator 310 can be fluidically coupled to a valve 325. The valve 325 can be configured to fluidically couple and decouple the gas regulator 310 to output(s).

In some cases, the valve 325 can be a two-way valve, where the gas regulator 310 is coupled to an output in an “on” state or decoupled from an output in an “off” state. In some cases, the gas regulator 310 can include a three-way valve, where the gas regulator is coupled to an output in an “on” state, decoupled to the output in an “off” state, and where the output is fluidically coupled to the environment external to the gas control device 300 in a “vent” state.

The valve 325 can be fluidically coupled to one or more outputs 330. The outputs 330 can output gas received from the gas regulator 310. The outputs 330 can be configured to include different connector types for coupling to downstream instrumentation. For example, the outputs 330 can include a spring-loaded compressor that closes an output when no connection is made; such a connection can be made by, for example, via a connector of the gas control device 300 or via a connector of a downstream instrumentation, and open when a connector is coupled to an output, which thereby allows gas to flow from the gas control device 300. An example of a downstream instrumentation can include a sample container of a sample interrogation system, for example system 100 of FIGS. 1 and 2). Downstream instrumentation can also be, for example, a column of a sample interrogation system, such as a column of a chromatography system, and the like.

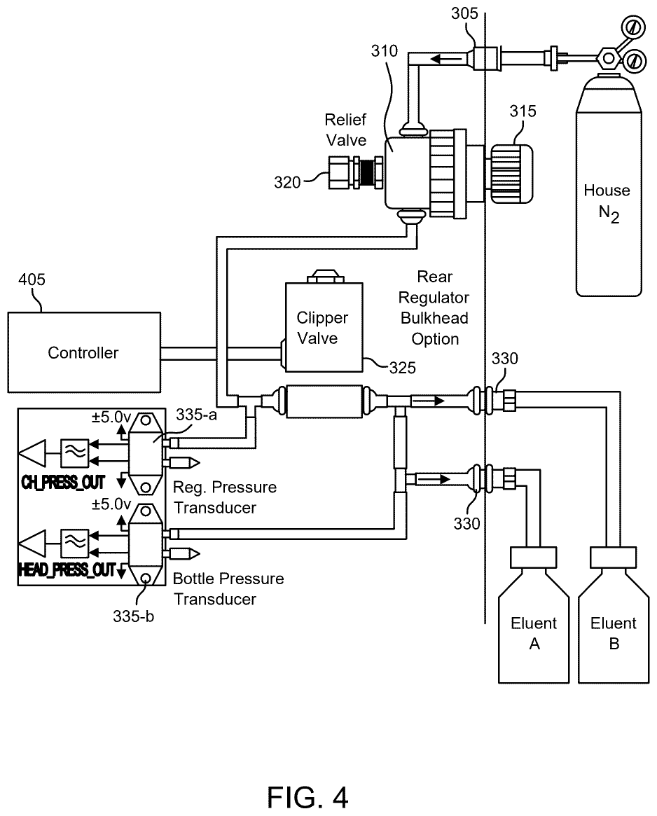

The gas control device 300 can also include one or more pressure sensors 335. The pressure sensors 335 can be fluidically coupled to one or more points of gas flow through the gas control device 300. For example, a pressure sensor can be fluidically coupled to the fluid channel coupling the gas regulator 310 to the valve 325. The pressure sensor 335-a of FIG. 4 depicts this example. As another example, a pressure sensor can be coupled to the fluid channel coupling the valve 325 to the output 330. The pressure sensor 335-b shows this example. Although FIG. 4 shows two pressure sensors, this is illustrative only, as the gas control device 300 can include one or more pressure sensors coupled along the fluid pathway—for example, from input to output—and the pressure sensors can be coupled at various points along the fluid pathway.

A pressure sensor 335 can measure pressure of the fluid pathway at the point where the pressure sensor 335 is coupled to the fluid pathway. In some cases, the pressure sensor 335 can be a pressure transducer.

The gas control device 300 can also include a display 340. The display 340 can be an example of display 110 as discussed with reference to FIG. 1. The display 340 can be in electronic communication with the pressure sensor 335. The display 340 can receive the measurements of the pressure sensor 335 and can display the measurements, for example, by converting the measurements to a digital visualization.

In some cases, the display 340 can include a toggle or other mechanism for a user to provide input. The toggle can control the state of the valve 325. For example, the toggle can be in electronic communication with the valve 325, for example via communication pathway 345. Actuating the toggle or other user input received by the toggle/user input mechanism can cause the valve 325 to switch between on/off/vent states of the valve 325. For example, pushing the toggle can cause the valve 325 to switch from coupling the gas regulator 310 to output 330, to decoupling the gas regulator 310 from the output 330, or vice versa. In another example, pushing the toggle can cause the valve 325 to switch from coupling the gas regulator 310 to output 330, to venting or purging the output 330 to an external environment, or vice versa. In another example, pushing the toggle can cause the valve 325 to switch from decoupling the gas regulator 310 to output 330, to venting or purging the output 330 to an external environment, or vice versa. In some cases, the display 340 can include a button for switching measurement readings between pressure sensors 335, for example, in cases where the gas control device 300 includes more than one pressure sensor.

In some cases, the gas control device 300 can be manually controlled. For example, the gas control device 300 can be coupled to a gas source at the input 305, and to a instrument at the output 330. A user can regulate the gas arriving from the gas source via the gas regulator 310. For example, the user can adjust the knob/mechanism of the gas regulator 310 to a pressure value. The user can monitor the display 340 for pressure readings within the gas control device 300. The user can make an informed decision on whether the pressure is adequate based on the location of the pressure sensor 335 and the state of the valve 325. For example, the valve can be on or off, which can influence the pressure readings of the sensors 330. Further, a pressure reading where the pressure sensor is coupled prior to the valve 325 can differ, in some cases, from a pressure reading where the pressure sensor is coupled after the valve 325. Depending on these factors, and the pressure readings of the display 340, the user can adjust the pressure via the gas regulator 310. As shown, a device can comprise a flow path, which flow path can comprise input 305, gas regulator 310, valve 325, and outputs 330.

In some cases, the gas control device 300 can include a controller, such as the controller 405 shown in FIG. 4. The controller 405 can be in electronic communication with the valve 325 and the pressure sensors 335. The controller 405 can be configured to monitor parameters of the gas control device 300 and control the state of the valve 325. For example, the controller 405 can monitor pressure readings of the pressure sensors 335. The controller 405 can cause the valve 325 to switch states—for example, between on, off, and vent states—based on the pressure readings. For example, the controller 405 can determine whether a pressure reading exceeds or falls below a pressure threshold, whether a differential in pressure readings exceeds or falls below a differential threshold, whether a length of time exceeds or falls below a time threshold, a combination thereof, and the like. Further, in some cases, the controller 405 can control the state of the valve 325 based on a schedule or program. For example, the controller can cause the valve 325 to switch states based on a schedule time, threshold, differential, or a combination thereof. In some cases, the controller 405 can control the gas regulator 310. For example, the controller 405 can be in electronic communication with the gas regulator 310. The controller 405 can cause the gas regulator 310 to adjust the pressure level of the gas source. In some cases, this adjustment can be based on a time threshold, a pressure reading threshold, a pressure differential, a schedule or program, or a combination thereof. In some cases, the controller 405 can be integrated, such as in a housing, of the gas control device 300. In some cases, the controller 405 can be a component of a computing system coupled to the gas control device 300, such as a computing system of a corresponding sample interrogation system, for example a computing system configured to analyze samples of the sample interrogation system.

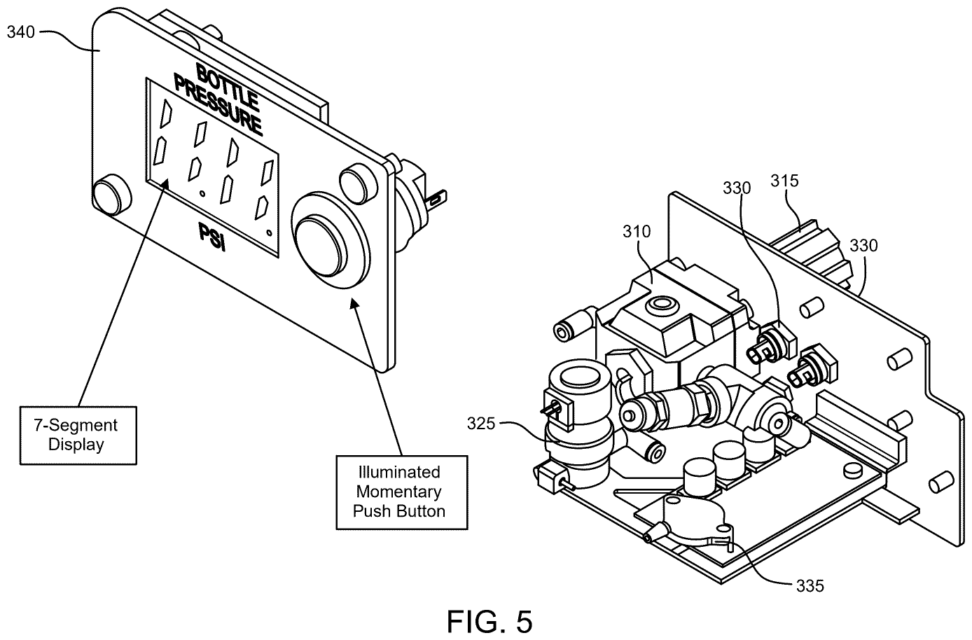

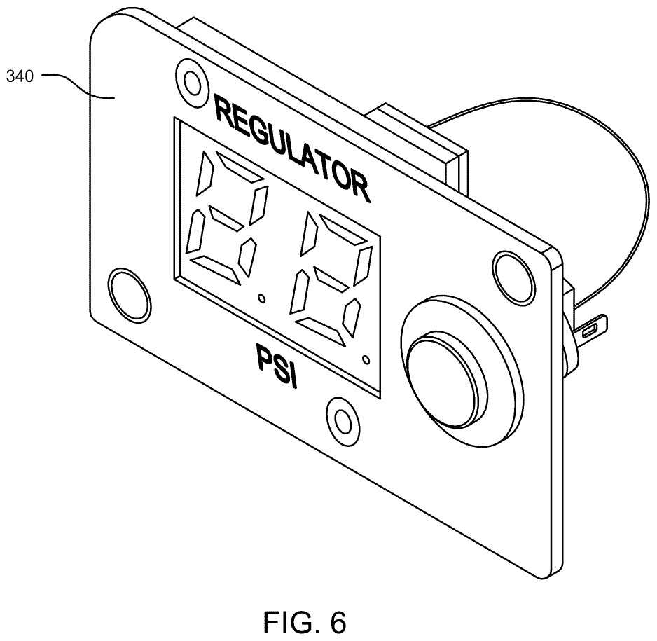

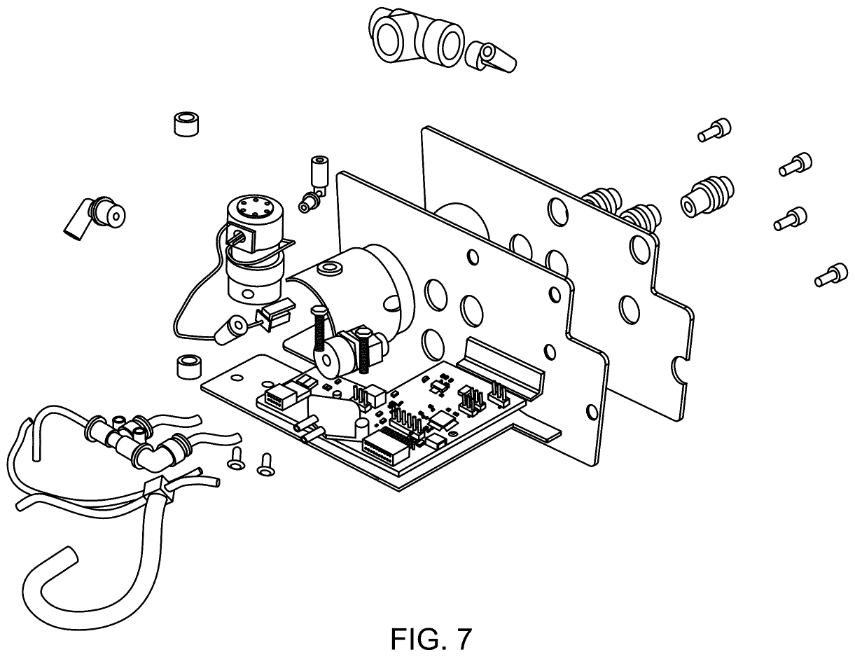

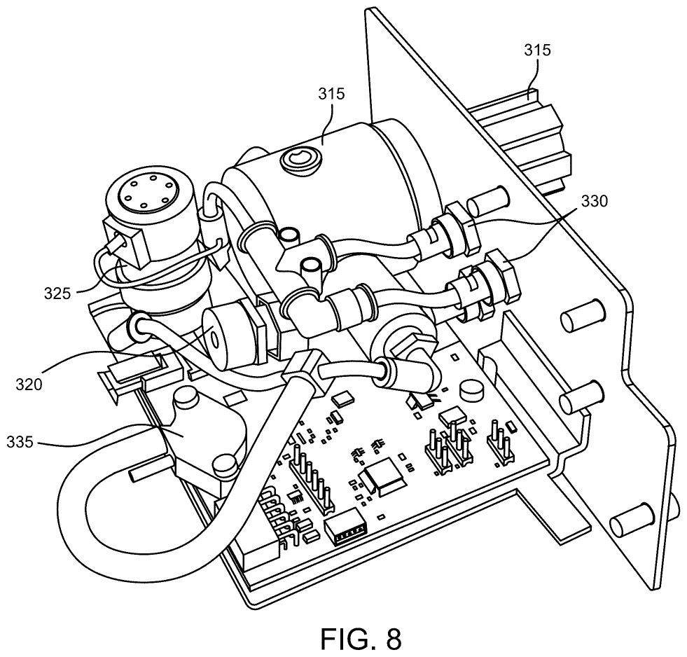

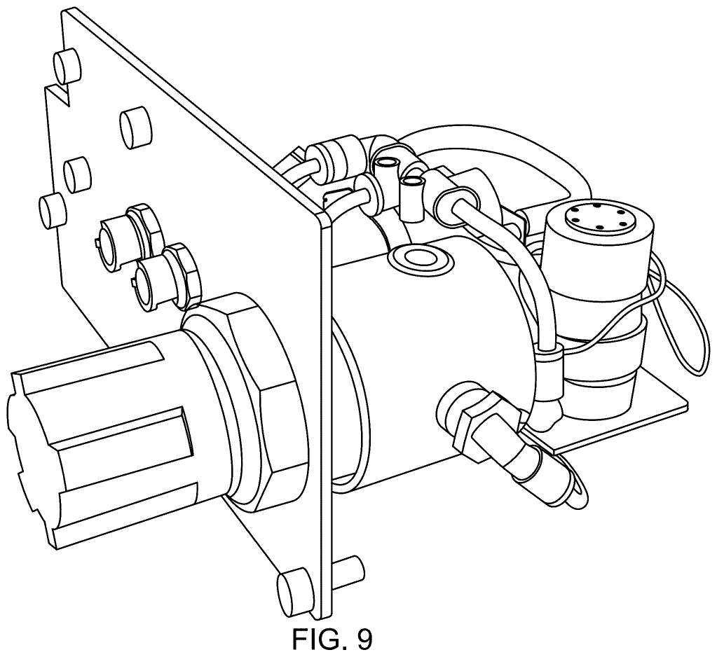

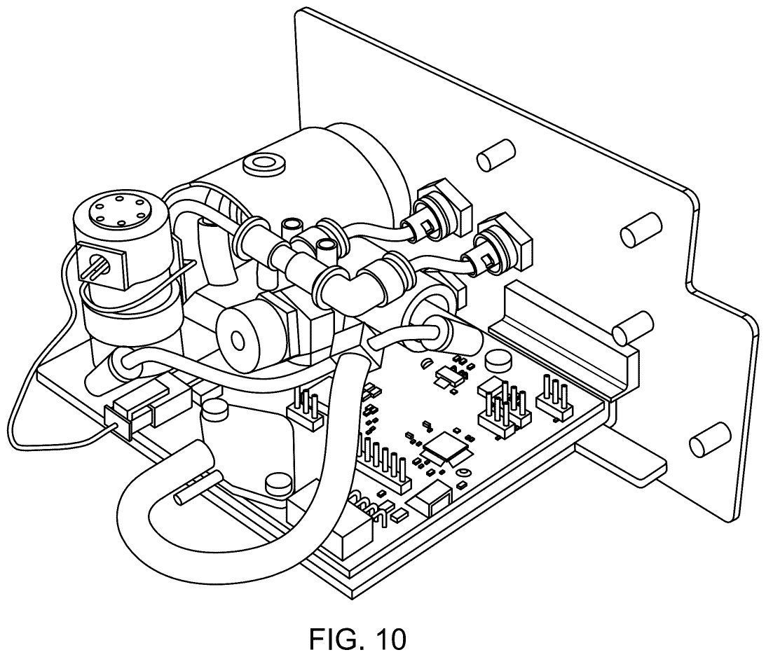

FIGS. 5-10 depict various perspective views of components of the gas control device according to the present disclosure.

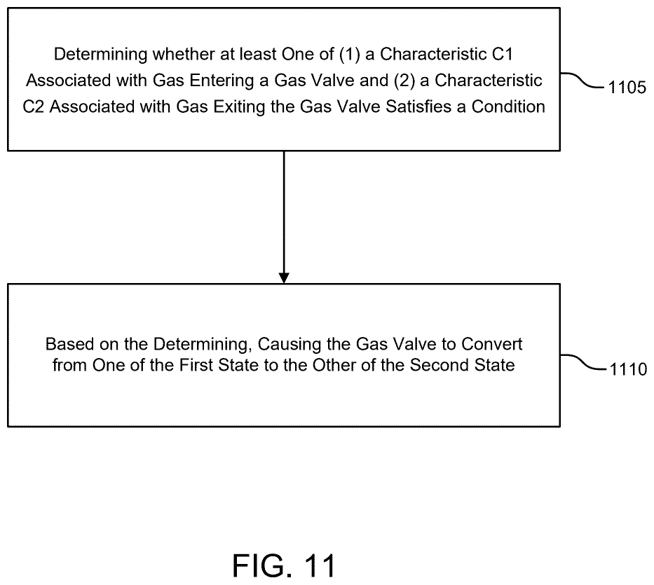

FIG. 11 depicts a process for implementing a gas control device according to the present disclosure. The gas control device can be an example of gas control device depicted in FIG. 3 or FIG. 4. In some cases, the process can be performed by a controller, such as controller 405 of FIG. 4.

At Step 1105, a controller can determine whether at least one of (1) a characteristic C1 associated with gas entering a gas valve and (2) a characteristic C2 associated with gas exiting the gas valve satisfies a condition. In some cases, the gas valve can be fluidically coupled to a gas regulator and a gas output. In some cases, the gas valve can be convertible among at least (1) a first state in which the gas regulator and the gas output are placed into fluid communication with one another and (2) a second state in which the gas regulator and the gas output are placed into fluid isolation from one another.

At Step 1110, the controller can cause, based on the determining, the gas valve to convert from one of the first state to the other of the second state. In some cases, at least one of C1 and C2 is any one or more of a time value, a gas flow rate value, a gas flow rate differential, and a pressure; pressure is particularly preferred but also is not a requirement. In some cases, the gas valve is further convertible to and from a third state in which the gas output is (a) placed into fluid communication with an environment exterior to the gas valve and (b) placed into fluid isolation from the gas regulator. In some cases, the system can include a gas chromatography system. In some cases, the determining and the causing are according to a schedule in electronic storage, and accessible by the controller.

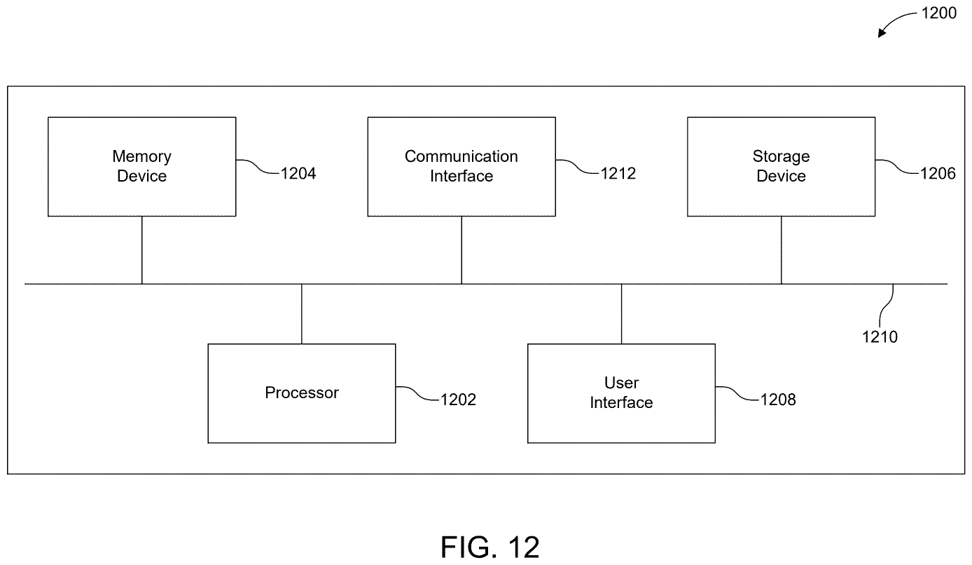

FIG. 12 depicts a controller 1200 according to the present disclosure. The controller 1200 can be an example of controller 405 discussed with reference to FIG. 4.

The controller 1200 can be a computing device such as a microcontroller, a general purpose computer—which can be, for example, a personal computer or PC—a workstation, a mainframe computer system, and so forth. The controller 1200 can include a processor device 1202—which can be, for example, a central processing unit or “CPU”, a memory device 1204, a storage device 1206, a user interface 1208, a system bus 1210, and a communication interface 1212.

The processor 1202 can be any type of processing device for carrying out instructions, processing data, and so forth.

The memory device 1204 can be any type of memory device including any one or more of random access memory (“RAM”), read-only memory (“ROM”), Flash memory, Electrically Erasable Programmable Read Only Memory (“EEPROM”), and so forth.

The storage device 1206 can be any data storage device for reading/writing from/to any removable and/or integrated optical, magnetic, and/or optical-magneto storage medium, and the like; storage can be, for example, a hard disk, a compact disc-read-only memory “CD-ROM”, CD-ReWritable CDRW,” Digital Versatile Disc-ROM “DVD-ROM”, DVD-RW, and so forth. The storage device 1206 can also include a controller/interface for connecting to the system bus 1210. Thus, the memory device 1204 and the storage device 1206 are suitable for storing data as well as instructions for programmed processes for execution on the processor 1202.

The user interface 1208 can include a touch screen, control panel, keyboard, keypad, display or any other type of interface, which can be connected to the system bus 1210 through a corresponding input/output device interface/adapter.

The communication interface 1212 can be adapted and configured to communicate with any type of external device, or with other components of the gas control device. The communication interface 1212 can further be adapted and configured to communicate with any system or network, such as one or more computing devices on a local area network (“LAN”), wide area network (“WAN”), the Internet, and so forth. The communication interface 1212 can be connected directly to the system bus 1210 or can be connected through a suitable interface.

The controller 1200 can, thus, provide for executing processes, by itself and/or in cooperation with one or more additional devices, that can include algorithms for controlling components of the sample interrogation system in accordance with the present disclosure. The controller 1200 can be programmed or instructed to perform these processes according to any communication protocol and/or programming language on any platform. Thus, the processes can be embodied in data as well as instructions stored in the memory device 1204 and/or storage device 1206, or received at the user interface 1208 and/or communication interface 1212 for execution on the processor 1202.

### EXEMPLARY EMBODIMENTS

The following embodiments are exemplary only and do not serve to limit the scope of the present disclosure of the appended claims. It should be understood that any part of any one or more Embodiments can be combined with any part of any other one or more Embodiments.

### Embodiment 1

A device for controlling gas flow, comprising: a gas input configured to receive gas from a gas source; a gas regulator in fluid communication with the gas input and configured to receive user input and regulate a gas flow of the gas based on the user input; a gas output configured to output from the device; a gas valve in fluidic communication with the gas regulator and the gas output, the gas valve being convertible among at least (1) a first state in which the gas regulator and the gas output are placed into fluid communication with one another and (2) a second state in which the gas regulator and the gas output are placed into fluid isolation from one another, and optionally (3) a third state in which the gas output is (a) placed into fluid communication with an environment exterior to the gas valve and (b) placed into fluid isolation from the gas regulator; and one or more sensors configured to output (1) a characteristic C1 associated with gas located between the gas regulator and the gas valve, (2) a characteristic C2 associated with gas located between the gas valve and the gas output, or both (1) and (2).

### Embodiment 2

The device according to Embodiment 1, further comprising a display configured to display at least one of characteristic C1 and characteristic C2.

### Embodiment 3

The device according to any of Embodiments 1 and 2, wherein the gas valve is in communication with a control configured for receiving an input, the input optionally being a manual input, and wherein the gas valve is configured to convert between a state and a different state based on the input.

### Embodiment 4

The device according to any of Embodiments 1 through 3, wherein a sensor comprises a pressure transducer.

### Embodiment 5

The device according to any of Embodiments 1 through 4, wherein the gas regulator further comprises a relief valve.

### Embodiment 6

The device according to any of Embodiments 1 through 5, wherein at least one of C1 and C2 is any one or more of a time value, a gas flow rate value, a gas flow rate differential, and a pressure.

### Embodiment 7

The device according to any of Embodiments 1 through 6, further comprising a controller in electronic communication with the gas valve, the controller being configured to cause the gas valve to convert from a state to a different state based on a comparison of C1 with a threshold, based on a comparison of C2 with a threshold, or both.

### Embodiment 8

The device according to any of Embodiments 1 through 7, wherein the controller is further configured to: determine an existence of a gas leak of the device based on the comparison of C1 with a threshold, based on a comparison of C2 with a threshold, or both; and provide a notification indicative of the gas leak.

### Embodiment 9

The device according to any of Embodiments 1 through 8, wherein the gas output is coupled to a chromatography system.

### Embodiment 10

A method for controlling gas flow in a system, comprising: determining whether at least one of (1) a characteristic C1 associated with gas entering a gas valve and (2) a characteristic C2 associated with gas exiting the gas valve satisfies a condition, the gas valve being fluidically coupled to a gas regulator and a gas output, and the gas valve being convertible among at least (1) a first state in which the gas regulator and the gas output are placed into fluid communication with one another and (2) a second state in which the gas regulator and the gas output are placed into fluid isolation from one another; and based on the determining, causing the gas valve to convert from one of the first state to the other of the second state.

### Embodiment 11

The method of Embodiment 10, wherein at least one of C1 and C2 is any one or more of a time value, a gas flow rate value, a gas flow rate differential, and a pressure.

### Embodiment 12

The method of any Embodiments 10 and 11, wherein the gas valve is further convertible to and from a third state in which the gas output is (a) placed into fluid communication with an environment exterior to the gas valve and (b) placed into fluid isolation from the gas regulator.

### Embodiment 13

The method of any of Embodiments 10 through 12, wherein the system comprises a gas chromatography system.

### Embodiment 14

The method of any of Embodiments 10 through 13, wherein the method is performed by a controller of a gas control device.

### Embodiment 15

The method of any of Embodiments 10 through 14, wherein the determining and the causing are according to a schedule in electronic storage, and accessible by the controller.

### Embodiment 16

The method of any of Embodiments 10 through 15, further comprising: receiving, from at least one sensor, information corresponding to either C1, C2, or both, and wherein the determining is based on the received information.

### Embodiment 17

The method of any of Embodiments 10 through 16, wherein the at least one sensor comprises at least one pressure transducer.

### Embodiment 18

A non-transitory, computer-readable medium storing instructions that, when executed by a processor, cause: determining whether at least one of (1) a characteristic C1 associated with gas entering a gas valve and (2) a characteristic C2 associated with gas exiting the gas valve satisfies a condition, the gas valve being fluidically coupled to a gas regulator and a gas output, and the gas valve being convertible among at least (1) a first state in which the gas regulator and the gas output are placed into fluid communication with one another and (2) a second state in which the gas regulator and the gas output are placed into fluid isolation from one another; and based on the determining, causing the gas valve to convert from one of the first state to the other of the second state.

### Embodiment 19

The non-transitory, computer-readable medium of Embodiment 18, wherein at least one of C1 and C2 is any one or more of a time value, a gas flow rate value, a gas flow rate differential, and a pressure.

### Embodiment 20

The non-transitory, computer-readable medium of any of Embodiments 18 and 19, wherein the gas valve is further convertible to and from a third state in which the gas output is (a) placed into fluid communication with an environment exterior to the gas valve and (b) placed into fluid isolation from the gas regulator.

What is claimed:

1. A device for controlling gas flow, comprising:
a gas input configured to receive gas from a gas source;
a gas regulator in fluid communication with the gas input and configured to receive user input and regulate a gas flow of the gas based on the user input;
a gas output configured to output from the device;
a gas valve in fluidic communication with the gas regulator and the gas output, the gas valve being convertible among at least (1) a first state in which the gas regulator and the gas output are placed into fluid communication with one another and (2) a second state in which the gas regulator and the gas output are placed into fluid isolation from one another, and optionally (3) a third state in which the gas output is (a) placed into fluid communication with an environment exterior to the gas valve and (b) placed into fluid isolation from the gas regulator; and
one or more sensors configured to output (1) a characteristic C1 associated with gas located between the gas regulator and the gas valve, (2) a characteristic C2 associated with gas located between the gas valve and the gas output, or both (1) and (2).

2. The device of claim 1, further comprising a display configured to display at least one of characteristic C1 and characteristic C2.

3. The device of claim 1, wherein the gas valve is in communication with a control configured for receiving an input, the input optionally being a manual input, and wherein the gas valve is configured to convert between a state and a different state based on the input.

4. The device of claim 1, wherein a sensor of the one or more sensors comprises a pressure transducer.

5. The device of claim 1, wherein the gas regulator further comprises a relief valve.

6. The device of claim 1, wherein at least one of C1 and C2 is any one or more of a time value, a gas flow rate value, a gas flow rate differential, and a pressure.

7. The device of claim 1, further comprising a controller in electronic communication with the gas valve, the controller being configured to cause the gas valve to convert from a state to a different state based on a comparison of C1 with a threshold, based on a comparison of C2 with a threshold, or both.

8. The device of claim 7, wherein the controller is further configured to:
determine an existence of a gas leak of the device based on the comparison of C1 with a threshold, based on a comparison of C2 with a threshold, or both; and
provide a notification indicative of the gas leak.

9. The device of claim 1, wherein the gas output is coupled to a chromatography system.

10. A method for controlling gas flow in a system, comprising:
determining whether at least one of (1) a characteristic C1 associated with gas entering a gas valve and (2) a characteristic C2 associated with gas exiting the gas valve satisfies a condition,
the gas valve being fluidically coupled to a gas regulator and a gas output, and
the gas valve being convertible among at least (1) a first state in which the gas regulator and the gas output are placed into fluid communication with one another and (2) a second state in which the gas regulator and the gas output are placed into fluid isolation from one another; and
based on the determining, causing the gas valve to convert from one of the first state to the other of the second state.

11. The method of claim 10, wherein at least one of C1 and C2 is any one or more of a time value, a gas flow rate value, a gas flow rate differential, and a pressure.

12. The method of claim 10, wherein the gas valve is further convertible to and from a third state in which the gas output is (a) placed into fluid communication with an environment exterior to the gas valve and (b) placed into fluid isolation from the gas regulator.

13. The method of claim 10, wherein the system comprises a gas chromatography system.

14. The method of claim 10, wherein the method is performed by a controller of a gas control device.

15. The method of claim 14, wherein the determining and the causing are according to a schedule in electronic storage, and accessible by the controller.

16. The method of claim 10, further comprising:
receiving, from at least one sensor, information corresponding to either C1, C2, or both, and wherein the determining is based on the received information.

17. The method of claim 16, wherein the at least one sensor comprises at least one pressure transducer.

18. A non-transitory, computer-readable medium storing instructions that, when executed by a processor, cause:
determining whether at least one of (1) a characteristic C1 associated with gas entering a gas valve and (2) a characteristic C2 associated with gas exiting the gas valve satisfies a condition,
the gas valve being fluidically coupled to a gas regulator and a gas output, and
the gas valve being convertible among at least (1) a first state in which the gas regulator and the gas output are placed into fluid communication with one another and (2) a second state in which the gas regulator and the gas output are placed into fluid isolation from one another; and
based on the determining, causing the gas valve to convert from one of the first state to the other of the second state.

19. The non-transitory, computer-readable medium of claim 18, wherein at least one of C1 and C2 is any one or more of a time value, a gas flow rate value, a gas flow rate differential, and a pressure.

20. The non-transitory, computer-readable medium of claim 18, wherein the gas valve is further convertible to and from a third state in which the gas output is (a) placed into fluid communication with an environment exterior to the gas valve and (b) placed into fluid isolation from the gas regulator.
